(19) United States
(12) Patent Application Publication
(10) Pub. No.: US 2005/0008562 A1
(43) Pub. Date: Jan. 13, 2005

(54) Nanostructured carbon materials having excellent crystallinity and large surface area suitable for fuel cell electrodes and method for synthesizing the same

(75) Inventors: Taegwhan Hyeon, Seoul (KR); Sangjin Han, Seoul (KR)

Correspondence Address: MARGER JOHNSON & MCCOLLOM PC, 1030 SW MORRISON STREET, PORTLAND, OR, 97205, US

(73) Assignee: Seoul National University, Seoul (KR)

(21) Appl. No.: 10/658,586

(22) Filed: Sep. 8, 2003

(30) Foreign Application Priority Data
Jul. 10, 2003 (WO) PCT/KR03/01377

(51) Int. Cl. C01B 31/04

(52) U.S. Cl. 423/448

(57) ABSTRACT

A method for synthesizing nanostructured carbon materials having excellent crystallinity and large surface area using inexpensive metal salts and polymeric carbon precursors are disclosed. The synthetic method comprises the formation of nanostructured carbon material—metal—inorganic oxide composite through catalytic graphitization of a polymeric carbon precursor—metal salt—inorganic oxide composite, removal of inorganic oxide using an etchant, and removal of metal through an acid treatment, wherein an inorganic oxide material is added in the reaction mixture in order to increase the surface area of the nanostructured carbon material, and metal salt is used as a graphitization catalyst. The resultant nanostructured carbon materials possess the characteristics of excellent crystallinity and large surface area, where such characteristics are well suited for low temperature fuel cell electrode applications.

### TECHNICAL FIELD

The present invention relates to a method for synthesizing nanostructured carbon materials having excellent crystallinity, large surface area, and suitable for fuel cell electrode applications using catalytic graphitization of polymeric carbon precursors.

### BACKGROUND ART

Since the discovery of carbon nanotubes by Iijima [Iijima, S., “Helical, Microtubules of Graphitic Carbon”, Nature 354, 56-58 (1991)], nanostructured carbon materials have been attracting a great deal of attention for possible applications in electron field emitters, catalytic supports, nanocomposites, quantum electronic devices, and electrode materials [Subramoney, S., “Novel Nanocarbon-structures, Properties, and Potential Applications”, Adv. Mater. 10, 1157-1171 (1998)]. Many forms of carbon nanostructures including carbon nanotubes, graphitic carbon nanofibers (GCNF), and carbon onions have been produced using various gas-phase reactions [Rodriguesz, N. M., “A Review of Catalytically Grown Carbon Nanofibers”, J. Mater. Res. 8, 3233-3250 (1993); Ebbesen, T. W. & Ajayan, P. M., “Large-scale Synthesis of Carbon Nanotubes”, Nature 358, 220-221 (1992)]. For producing synthetic nanostructured carbon materials, the methods of arc discharge, laser evaporation and thermal chemical vapor deposition are typically used. However, these synthetic methods have limitations in terms of economical mass production capability because of harsh synthesis conditions and low production yield. For example, the laser evaporation method utilizes evaporation of the graphite electrode using laser irradiation, which technique is very expensive for producing the synthetic nanostructured carbon materials in large quantities. As a second example, the arc discharge method produces highly crystalline carbon nanotubes, however, this process has a very low yield, thereby, is not practical for mass production. As yet another example, the chemical vapor deposition method utilizing a thermal decomposition process of hydrocarbon precursors catalyzed by transition metal catalysts such as iron, cobalt, and nickel can also be used. The advantage of this process is that it is relatively inexpensive. But the disadvantage is poor quality of the resulting nanostructured carbon material.

For a long time, transition metals such as iron, cobalt and nickel, and their alloys have been utilized as graphitization catalysts. Use of these transition metal catalysts lowered the graphitization temperature to below 1000° C. In contrast, when the catalysts are not used, high temperature over 2700° C. is required to obtain graphitic carbon materials. However, in most graphitic carbon synthesis processes using said transition metal catalysts, gaseous carbon precursors are used. There are very few reports on the synthesis of nanostructured carbon materials from the catalytic thermal reaction of polymeric carbon precursors using transition metal catalysts [Cho, W., Hanada, E., Kondo, Y. & Takayanagi, K., “Synthesis of Carbon Nanotubes from Bulk Polymer,” Appl. Phys. Lett. 69, 278-279 (1996); Kiselev, N. A., Sloan, J., Zakharov, D. N., Kukovitskii, E. F., Hutchison, J. L., Hammer, J. & Kotosonov, A. S., “Carbon Nanotubes from Polyethylene Precursors: Structure and Structural Changes Caused by Thermal and Chemical Treatment Revealed by HREM,” Carbon 36, 1149-1157 (1998); and Maldonado-Hódar, F. J., Morenno-Castilla, C., Rivera-Utrilla, J., Hanzawa, Y., and Yamada, Y., “Catalytic Graphitization of Carbon Aerogels by Transition Metals,” Langmuir 16, 4367-4373 (2000)]. However, these synthetic processes cannot be used for economical and large-scale production of such nanostructured carbon materials because of long reaction time or complicated synthetic procedures.

Carbon is one of the essential materials for fuel cell electrode applications, particularly, for low temperature fuel cells such as polymer electrolyte membrane fuel cells (PEMFCs) as well as direct methanol fuel cells (DMFCs). Quality and characteristics of a carbon material play a key role in determining the efficiency and performance of the fuel cells. No other material has the essential properties of electrical conductivity, corrosion resistance, surface area requirements, and the low cost necessary for commercialization of fuel cells. Low cost is an essential part of the desirable features of the carbon materials for fuel cell applications. In recent years, direct methanol fuel cells (DMFCs), whereby methanol is directly used as a fuel, have been intensely studied because of their numerous advantages such as high energy density, the ease of fuel handling, low operating temperature, and their possible applications to miniaturization of fuel cells. The performance and long-term stability of low temperature fuel cells, such as PEMFCs and also DMFCs that operate at room temperature, are known to be strongly dependent upon carbon supports as well as catalytically active species. Accordingly, for the best performance of the DMFC, it is essential to develop an excellent carbon material for the catalyst support. For successful applications to electrodes for low temperature fuel cells, carbon materials should have the property of large surface area for effective dispersion of catalytically active species and in addition carbon materials should have the property of excellent crystallinity for effective electron transport. However, it is widely known that it is extremely difficult to synthesize carbon materials having the properties of both large surface area and excellent crystallinity. The primary objective of the present invention is, therefore, to disclose nanostructured carbon materials and a method for synthesizing the same having the properties of excellent crystallinity and large surface area.

Many activated carbons have a surface area exceeding 2000 m²/g, these carbon materials are amorphous, and yet they have very poor crystallinity. On the other hand, graphite is highly crystalline, while it has a very small surface area less than 10 m²/g.

The surface area of a powder including carbon materials is routinely determined by measuring the amount of gas molecules that are adsorbed to form a monolayer. Brunauer, Emmett, and Teller developed a theory (BET method) for the -adsorption of gases on solids, which is based on the Langmuir adsorption isotherm [Patrick, J. W., “Porosity in Carbons: Characterization and Applications” Edward Arnold, London, 1995]. Generally, N₂ gas is used as a gas adsorbent and its measured temperature is 77K. Other additional information available from the gas adsorption is the pore size distribution. Various theories may be used for calculating the pore size distribution from the gas isotherm data. Especially, Barrett-Joyner-Halenda(BJH) method is widely used for measuring the pore size in the mesopore region between 2 nm and 50 nm.

The crystallinity of carbon materials is usually characterized by X-ray diffraction (XRD) patterns and Raman spectroscopy [Kinoshita, K., “Carbon, Electrochemical and Physiochemical Properties”, John Wiley & Sons, New York, 1998]. The XRD analysis is one of the key techniques for characterizing carbon materials. The main information obtained from XRD data is the crystallinity and the size of crystallites. It is widely known that an ideal graphite structure consists of layers of carbon atoms arranged in hexagonal rings that are stacked in a sequence of ABAB . . . . The distance between hexagonal planes is known as d-spacing of (002). For an ideal graphite, the d-spacing of (002) is 3.354 Å. The higher the crystallinity of a carbon material is, the nearer the d-spacing of (002) of the carbon material is to that of graphite. Other information contained in the X-ray diffraction (XRD) data is the size of the crystallites. Dimension of the carbon crystallites is determined from the analysis of XRD line broadening [Kinoshita, K., “Carbon, Electrochemical and Physiochemical Properties”, John Wiley & Sons, New York, 1998]. The layer dimension Lₐ in the plane of the layers, which is the size of the crystallites parallel to the graphite basal plane, is calculated by using the equation Lₐ=1.84λ/(B cos θ), where λ is the wavelength of the X-ray beam, B is the angular width of the diffraction peak at the half-maximum intensity, and θ is the Bragg angle. The layer dimension perpendicular to the basal plane of the graphites L_{c} is obtained from the (002) reflection and the corresponding equation for calculating L_{c} is L_{c}=0.89λ/(B cos θ). Raman spectroscopy is based on the Raman effect, in which light, usually monochromatic light in the visible wavelength region, interacts with a sample to give rise to a small fraction of inelastically scattered radiation of shifted wavelengths. The Raman absorption bands (molecular or lattice optical modes) are used for characterizing the properties of a sample, whereby the widths at the half maximum of the Raman absorption bands are used for estimating the crystallinity [Kinoshita, K., “Carbon, Electrochemical and Physiochemical Properties”, John Wiley & Sons New York, 1998]. As an example, highly ordered graphites show a single Raman peak at the wave number of about 1580 cm⁻¹, called G-line (graphitic-line), whereas the carbon material with less graphitic structure shows an additional peak at about 1350 cm⁻¹, called D-line (disordered-line). Therefore, the peak intensity ratio, I_{D}/I_{G}, where I_{G} is the peak intensity value of the G-line and I_{D} is the peak intensity value of the D-line, respectively, is used for estimating the crystallinity of a carbon material. In addition, the distance between the Raman peaks of G-line and D-line, I_{G} and I_{D}, tend to broaden as the crystallite size decreases.

Among many carbon materials, Sample A produced by Company X is the most widely used support material for low temperature fuel cell (DMFC and PEMFC) electrodes, and this carbon material has been recognized as a standard carbon support material for low temperature fuel cell (DMFC and PEMFC) electrode applications. The XRD graph of Sample A exhibits that the (002) d-spacing of Sample A is 3.6 Å, and the measured crystallite size perpendicular to the basal plane (L_{c}) of Sample A, using Debye-Scherrer formula, is calculated to be 1.9 nm. The Raman spectroscopic data of Sample A exhibit that the intensity ratio of the D-line peak to the G-line peak, I_{D}/I_{G}, is about 1.2. The XRD and the Raman spectroscopic data for Sample A indicate that this carbon material has a poor graphitic crystallinity. The transmission electron microscope (TEM) image of this carbon material shows that the average size in diameter of the primary grains is about 30 nm, and the measured specific surface area of this carbon is 212 m²/g [Kinoshita, K., “Carbon, Electrochemical and Physiochemical Properties” John Wiley & Sons New York, 1998]. These deficiencies need improvements.

The main objective of the present invention is, therefore, to disclose the methods of synthesizing nanostructured carbon materials having excellent crystallinity and a large surface area, therefore, suitable for fuel cell electrode applications, yet overcoming the deficiencies aforementioned.

### DETAILED DESCRIPTION OF THE INVENTION

The present invention discloses the methods of synthesizing nanostructured carbon materials having excellent graphitic crystallinity and large surface area using catalytic graphitization of polymeric carbon precursors, where the resulting nanostructured carbon materials have the properties of excellent graphitic crystallinity and a large surface area desirable for low temperature fuel cell electrode applications. Such a large surface area and excellent crystallinity of the nanostructured carbon materials make the nanostructured carbon materials well suited for high performance fuel cell electrode applications at low temperatures.

A method of synthesizing nanostructured carbon materials is described in detail in reference to FIG. 1 showing the process of synthesizing nanostructured carbon materials through the catalytic graphitization process of polymeric carbon precursors using transition metal catalysts in the presence of inorganic oxide materials according to the present invention.

Specifically, according to the present invention and in reference to FIG. 1, a nanostructured carbon material is synthesized by the following four steps described below.

Step A 101: A polymeric carbon precursor—transition metal salt—inorganic oxide composite is synthesized by mixing and reacting one or more precursors for one or more polymeric carbon precursors in the presence of one or more transition metal salts and one or more inorganic oxide materials in a solvent. By synthesizing polymeric carbon precursors in-situ in the presence of transition metal salts and inorganic oxide materials, a nanometer-scaled homogeneous polymeric carbon precursor—transition metal salt—inorganic oxide composite is obtained, which is one of the most critical processes for synthesizing high quality nanostructured carbon materials in the present invention. For an economical reason, the process of mixing and reacting one or more precursors for one or more polymeric carbon precursors in the presence of one or more transition metal salts, and one or more inorganic oxide materials in a solvent can be replaced with the process of simply mixing one or more pre-prepared or commercially available polymeric carbon precursors, one or more transition metal salts, and one or more inorganic oxide materials in a solvent, to form a polymeric carbon precursor—transition metal salt—inorganic oxide composite. By using pre-prepared or commercially available polymeric carbon precursors, the overall process is simplified and, as a result, less costly, yet nanostructured carbon materials in good quality, which are comparable to the nanostructured carbon materials resulted in by using the process in Step A 101 in FIG. 1, is obtained. According to the present invention, the molar ratio of the polymeric carbon precursor to the metal salt is in the range of 20:1 to 1:2, and also the molar ratio of the polymeric carbon precursor to the inorganic oxide is in the range of 20:1 to 1:2.

Step B 102: A nanostructured carbon material—transition metal—inorganic oxide composite is produced through the catalytic graphitization of the polymeric carbon precursor—transition metal salts—inorganic oxide composite in Step A 101 by heat-treating under an inert gas atmosphere at a temperature ranging from 300° C. to 2500° C. for a time duration ranging from 0.1 to 50 hours according to the present invention.

Step C 103: A nanostructured carbon material—transition metal composite is produced by removing the inorganic oxide from the nanostructured carbon material—transition metal—inorganic oxide composite in Step B 102 by treating with an etching reagent.

Step D 104: The synthesis of a nanostructured carbon material is completed by removing the transition metals from the nanostructured carbon material—transition metal composite in Step C 103 by treating with an acid.

According to the present invention, the in-situ generated transition metal particles produced through the reduction of metal salt during the heat-treatment of the polymeric carbon precursor—metal salt composite in Step B 102 in FIG. 1 are used as a catalyst for catalytic graphitization of the polymeric carbon precursors. In other words, the in-situ generated carbon is acting as a reducing agent for the transition metal salt to produce the transition metal particles.

According to the present invention, an inorganic oxide material such as silica is added to the reaction mixture in Step A 101 in FIG. 1 to obtain the carbon materials having a large surface area, and to achieve good dispersion of transition metal particles for catalyzing the graphitic nanostructured carbon formation process.

More specifically, according to the present invention in reference to FIG. 1, in Step A 101, in synthesizing nanostructured carbon materials, the following polymeric carbon precursors including resorcinol-formaldehyde-gel (RF-gel), phenol-formaldehyde-gel, phenol resin, melamine-formaldehyde-gel, poly(furfuryl alcohol), poly(acrylonitrile), sucrose, polypyrrole, polydivinylbenzene and petroleum pitch are used as precursors for producing the desired nanostructured carbon materials, where such polymeric carbon precursors are readily available. In order for homogeneous mixing of polymeric carbon precursors, transition metal salts and inorganic oxide materials, said polymeric carbon precursors are synthesized in-situ in the presence of transition metal salts and inorganic oxide materials. For this process, those who are familiar with the art should be able to easily find an optimum condition for said in-situ synthesis of said polymeric carbon precursors.

According to the present invention and in reference to FIG. 1, in Step B 102, the catalytic graphitization process is conducted by heating said polymeric carbon precursor under an inert gas atmosphere at a temperature between 300° C. and 2500° C. to produce the desired nanostructured carbon materials and for a time duration ranging from 0.1 to 50 hours. For this process, those who is familiar with the art should be able to easily find an optimum condition for said catalytic graphitization process.

According to the present invention, in Step C 103 in FIG. 1, said inorganic oxide material is removed by reacting the resulting nanostructured carbon material—transition metal—inorganic oxide composite in Step B 102 with an etching reagent of concentration ranging from 0.01 M to 10 M and at a temperature between 10° C. and 300° C. Here, those who are familiar with the art should be able to easily find an optimum etching process condition for this process.

According to the present invention, in Step D 104 in FIG. 1, said transition metal is removed by reacting the resulting nanostructured carbon material—transition metal composite with an acid of concentration ranging from 0.01 M to 10 M and at a temperature between 10° C. and 300° C. to synthesize a nanostructured carbon material. Furthermore, those who are familiar with the art should be able to easily find an optimum condition for said acid treatment.

According to the present invention, in reference to FIG. 1, in Step A 101, for synthesizing nanostructured carbon materials, the following metal salts composed of metal cations including typically iron[Fe], cobalt[Co], nickel[Ni], molybdenum[Mo], vanadium[V], yttrium[Y], zirconium[Zr], niobium[Nb], lithium[Li], magnesium[Mg], aluminum[Al], silicon[Si], potassium[K], calcium[Ca], titanium[Ti], chromium[Cr], manganese[Mn], copper[Cu], zinc[Zn], gallium[Ga], germanium[Ge], arsenic[As], indium[In], tin[Sn], antimony[Sb], lanthanum[La], hafnium[Hf], tantalum[Ta], tungsten[W], and anions including typically acetate[CH₃COO⁻], acetylacetonate[CH₃COCH═C(O⁻)CH₃], fluoride[F⁻], chloride[Cl⁻], bromide[Br⁻], nitrate[NO₃⁻], sulfate[SO₄²⁻], phosphate [PO₄³⁻], oxalate[COO⁻], perchlorate[ClO₄⁻] and alkoxides[RO⁻] are used as catalyst precursors. Furthermore, mixtures of any combinations of two or more metal salts listed above are also used as catalyst precursors according to the present invention.

According to the present invention, in Step A 101 of FIG. 1, the inorganic oxide materials including typically silica[SiO₂], alumina[Al₂O₃], titania[TiO₂], ceria[CeO₂], zirconia[ZrO₂], tin oxide[SnO₂] and yttria[Y₂O₃] are used as pore inducing agent(porogen). Furthermore, mixtures of any combination of two or more inorganic oxides listed above are also used as pore inducing agent according to the present invention.

According to the present invention, in Step C 103 of FIG. 1, the following etching reagents including typically hydrofluoric acid[HF], sodium hydroxide[NaOH], potassium hydroxide[KOH], magnesium hydroxide[Mg(OH)₂], calcium hydroxide[Ca(OH)₂] and lithium hydroxide[LiOH] are used for removing inorganic oxide materials. Furthermore, mixtures of any combinations of two or more etching reagents listed above are also used as well according to the present invention.

According to the present invention, in reference to FIG. 1, in Step D 104, the following acids including typically hydrochloric acid[HCl], nitric acid[HNO₃], sulfuric acid[H₂SO₄], hydrofluoric acid[HF], phosphoric acid[H₃PO₄] and acetic acid[CH₃COOH] are used as acids for removing transition metals. Furthermore, mixtures of any combinations of two or more acids listed above are also used according to the present invention.

As aforementioned, the nanostructured carbon materials synthesized according to the present invention have unique characteristics of excellent crystallinity and a large surface area necessary for excellent fuel cell electrode applications.

The electron microscopic images of said nanostructured carbon materials synthesized using different synthesis conditions according to the present invention show the sphere-like particles with an average size in diameter ranging from 50 nm to 300 nm as shown in FIG. 4. Said particles are composed of the graphitic nanocoil-shaped particles with an average thickness ranging from 2 nm to 20 nm as shown in FIGS. 5 and 6.

Specifically, said nanostructured carbon materials according to the present invention have the following characteristics: (1) The X-ray diffraction graph of said nanostructured carbon materials exhibits three peaks; strong (002), second (100), and third (004) peaks. (2) The measured crystallite size perpendicular to the basal plane (L_{c}) of said nanostructured carbon material is in the range of 2 nm to 20 nm, and the average size in diameter of said sphere-like particles ranges from 50 nm to 300 nm, and furthermore, said sphere-like particles are composed of, seen in detail, the graphitic nanocoil-shaped particles with average thickness ranging from 2 nm to 20 nm. (3) The Raman spectroscopy data of said nanostructured carbon materials exhibit a G-line (graphitic-line) peak at a wave number between 1550 cm⁻¹ and 1610 cm⁻¹, and a D-line (disordered-line) peak at a wave number between 1325 cm⁻¹ and 1385 cm⁻¹. (4) The intensity ratio of the D-line peak (disordered-line) to the G-line peak (graphitic-line), I_{D}/I_{G}, is less than 1.0. (5) The specific surface area measured by the BET method is at least 200 m²/g.

### BRIEF DESCRIPTION OF THE DRAWINGS

FIG. 1 is a flow chart showing the process of synthesizing a nanostructured carbon material according to the present invention.

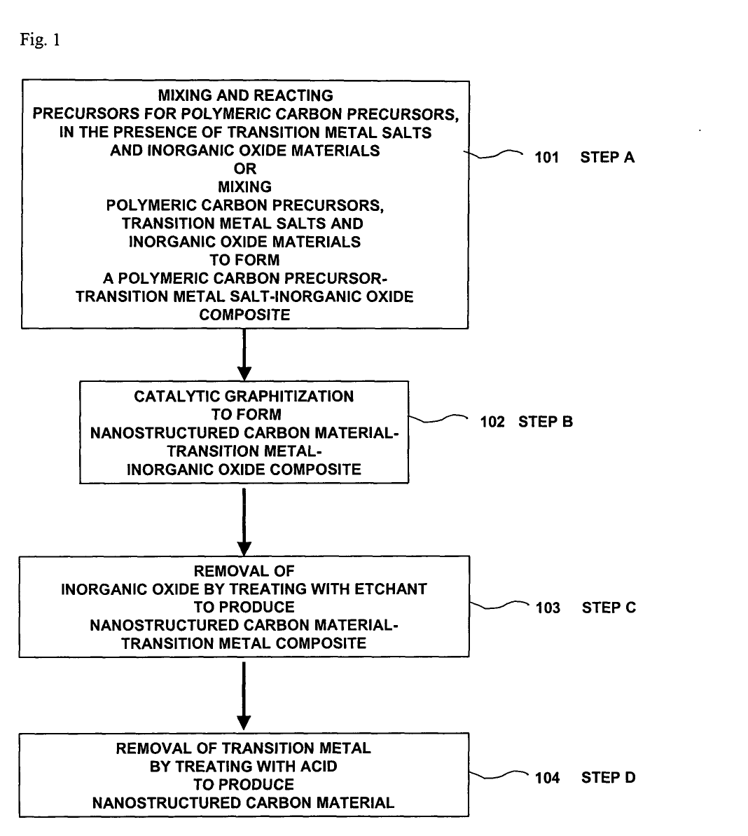

FIG. 2 is an exemplary X-ray diffraction (XRD) graph of a nanostructured carbon material synthesized according to Embodiment, where 2θ is the scattering angle.

FIG. 3 is an exemplary Raman Spectrum of a nanostructured carbon material synthesized according to Embodiment.

FIG. 4 is an exemplary scanning electron microscope (SEM) image of a nanostructured carbon material synthesized according to Embodiment, showing the sphere-like particles with an average size in diameter ranging from 50 nm to 300 nm.

FIG. 5 is an exemplary low-magnification transmission electron microscope (TEM) image of a nanostructured carbon material synthesized according to Embodiment, showing the graphitic nanocoil-shaped particles with an average thickness ranging from 2 nm to 20 nm.

FIG. 6 is an exemplary high-magnification TEM image of a nanostructured carbon material in FIG. 5 synthesized according to Embodiment, showing the graphitic nanocoil-shaped particles with an average thickness ranging from 2 nm to 20 nm.

FIG. 7 shows two comparative graphs illustrating the specific methanol electro-oxidation current vs. applied potential (E[v]) of PtRu (1:1) alloy catalyst (60 wt. %) supported on a nanostructured carbon material synthesized according to Embodiment, labeled as A, and that of Sample A produced by Company X, labeled as B, respectively.

FIG. 8 shows two exemplary, comparative, normalized chronoampherometic(CA) graphs illustrating the normalized current vs. time at 0.3V relative to N.H.E.(Normal Hydrogen Electrode), where the normalized current is obtained by taking the ratio of the measured oxidation current to the initial oxidation current of PtRu (1:1) alloy catalyst (60 wt. %) supported on the nanostructured carbon material synthesized according to Embodiment, labeled as A, and that of Sample A produced by Company X, labeled as B, respectively.

### BEST MODES FOR CARRYING OUT THE PRESENT INVENTION

The procedures and results of the best modes of carrying out the present invention are described in the following. However, the procedures and results presented here are merely illustrative examples of carrying out the implementation of the underlying ideas and procedures of the present invention, and the presentation of the exemplary Embodiment given in the following is neither intended for exhaustively illustrating the basic ideas and procedures nor limiting the scope of the present invention. Furthermore, those who are familiar with the art should be able to easily derive variations and modifications of the underlying ideas and procedures of the present invention.

For successful applications to the electrodes for low temperature fuel cells, the nanostructured carbon materials should have the property of large surface area for effective dispersion of catalytically active species and, in addition, such carbon materials should have the property of excellent crystallinity for effective electron transport.

The main objective of the present invention is to disclose a method of synthesizing nanostructured carbon materials using catalytic graphitization of polymeric carbon precursors, where the resulting nanostructured carbon materials possess excellent crystallinity and a large surface area, and therefore, are suitable for low temperature fuel cell electrode applications

### Embodiment

An aqueous reaction mixture with a molar ratio of H₂O:cobalt salt:nickel salt:resorcinol:formaldehyde:silica=100:0.4:0.4:1:2:0.6 is prepared by mixing the constituent materials in 100 mL of deionized water. The resulting reaction mixture is cured at 85° C. for 3 hours in a closed glass vial. For the catalytic graphitization, the composite is heated under a nitrogen atmosphere at 900° C. for 3 hours. The resulting composite is then stirred with 3 M NaOH solution for 3 hours to remove silica particles, and is then refluxed in 2.5 M HNO₃ solution for 1 hour to remove metal particles, resulting in forming a nanostructured carbon material. Inductively coupled plasma (ICP) analysis shows that transition metals are successfully removed by the acid treatment.

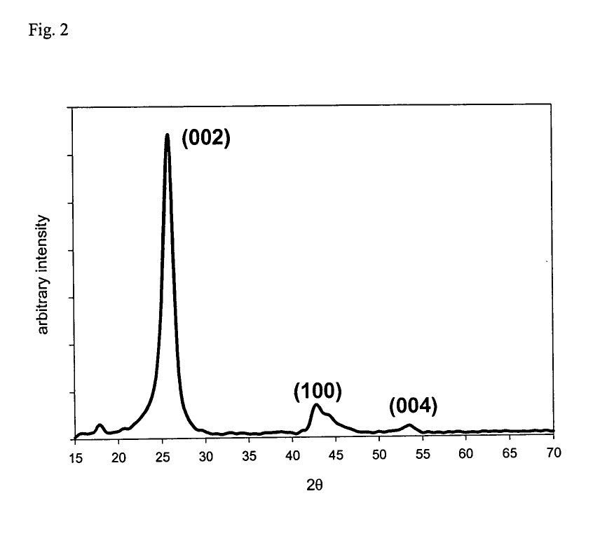

An X-ray diffraction (XRD) graph obtained from the resultant nanostructured carbon material is shown in FIG. 2, whereby the XRD graph exhibits that the carbon material is well graphitized with a (002) d-spacing of 3.43 Å, and (100) and (004) peaks are clearly observed. The measured crystallite size of the nanostructured carbon material in perpendicular to the basal plane (L_{c}), using Debye-Scherrer formula, is calculated to be 5.5 nm.

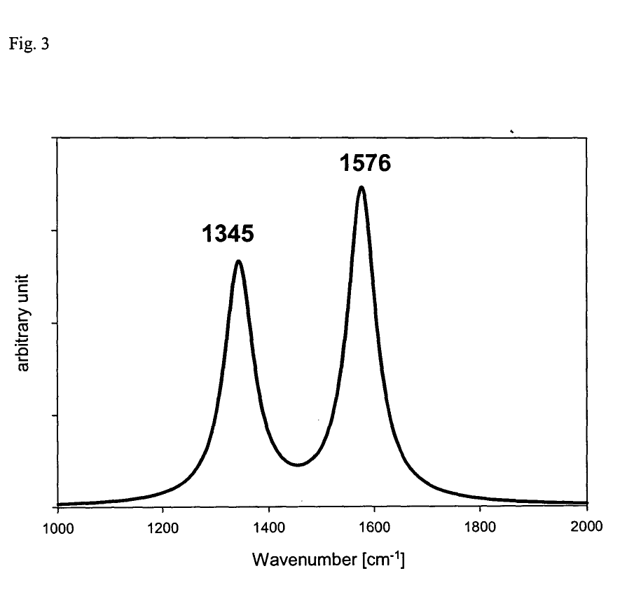

The Raman spectroscopic data shown in FIG. 3 exhibit the G-line peak, l_{G}, at 1576 cm⁻¹ and the D-line peak, I_{D}, at 1345 cm⁻¹, respectively. The intensity ratio of the D-line to the G-line, i.e., I_{D}/I_{G} is about 0.7, whereas the corresponding intensity ratio for Sample A produced by Company X is 1.2 [Kinoshita, K., “Carbon, Electrochemical and Physiochemical Properties”, John Wiley & Sons New York, 1998]. Both the XRD and the Raman spectroscopic results indicate that the resultant nanostructured carbon material synthesized by the method presented here according to the present invention is highly crystalline. The measured specific surface area of the resultant nanostructured carbon material is 318 m²g⁻¹.

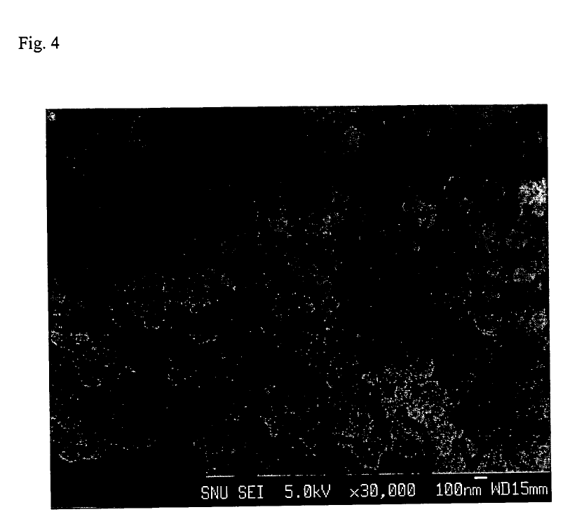

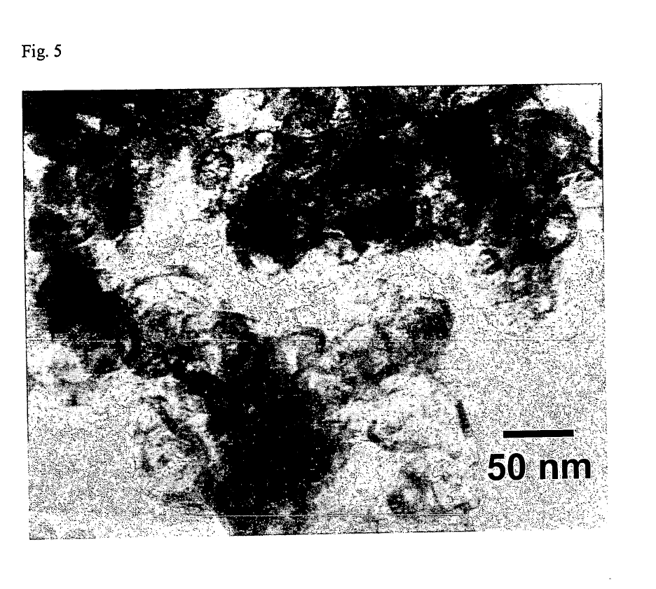

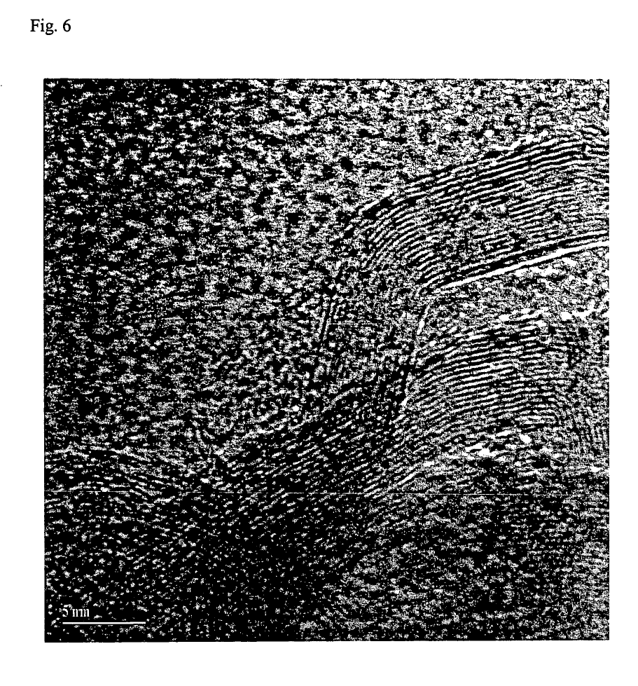

The SEM image in FIG. 4 shows that the nanostructured carbon material consists of the particles of about 100 nm in diameter. The low-magnification TEM image in FIG. 5 shows that the particles are composed of thick nanocoils in thickness ranging from 5 to 10 nm, thereby this result matches well with the L_{c} value of 5.5 nm calculated from the XRD data. The high-magnification TEM image of a single nanocoil in FIG. 6 shows well-aligned graphitic layers, demonstrating high crystallinity of the resultant nanostructured carbon material synthesized by the method disclosed here according to the present invention. This result also confirms with the results of the afore-described XRD analysis as well as the Raman spectroscopic data.

The XRD data and the Raman spectrum are measured using Rigaku D/Max-3C, and Jobin Yvon T64000 spectrometer, respectively. The specific surface area is obtained using ASAP 2000 and SEM image is taken from Jeol JSM-6700F. Low-magnification TEM images and high-magnification TEM images are collected using Jeol JEM-2000EXII and Jeol JEM-3000F, respectively.

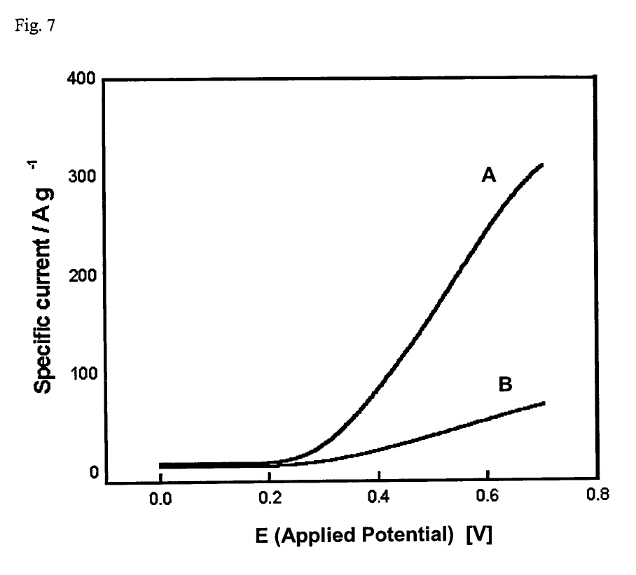

In a half-cell test performed for the methanol oxidation of direct methanol fuel cells at 0.6 V, as shown in FIG. 7, the performance of the electrode using the nanostructured carbon material resulted from Embodiment, labeled as A, shows six times higher specific current than that of Sample A produced by Company X, labeled as B, which sample is a widely used support material for low temperature fuel cell (DMFC and PEMFC) electrode applications, and is also well recognized as a standard carbon support material for low temperature fuel cell (DMFC and PEMFC) electrode applications, as described previously. For this test, 60 wt % of PtRu alloy catalyst with a 1:1 molar ratio are loaded on both said nanostructured carbon material and Sample A produced by Company X.

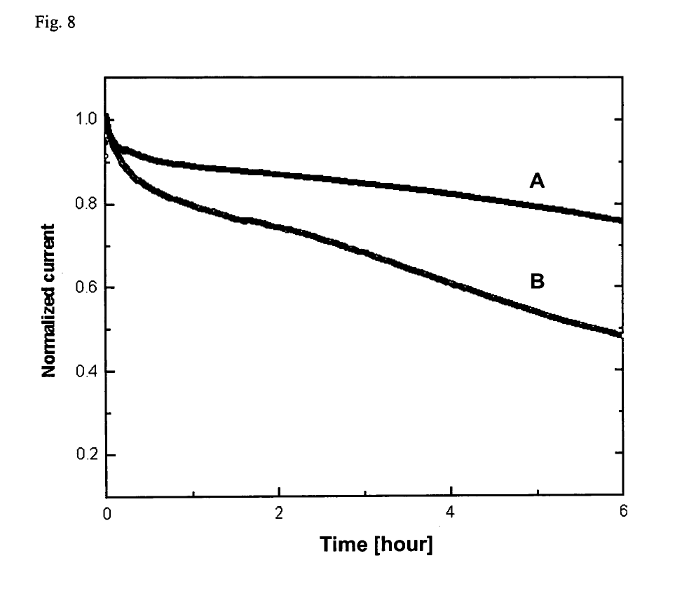

A graph of the normalized methanol oxidation current versus time at 0.3 V relative to N.H.E. (Normal Hydrogen Electrode) is shown in FIG. 8. The normalized current, which is defined as the ratio of the measured oxidation current to the initial oxidation current, is used for comparing the stability and durability of carbon materials for methanol oxidation. After about 6 hours, the electric current for Sample A, labeled as B, decreases to below 50% level of its initial value, whereas the nanostructured carbon material synthesized according to the present invention in Embodiment maintains much higher level of current and its activity, labeled as A, than that of Sample A. Specifically, the electric current in case of the synthesized nanostructured carbon material in Embodiment, labeled as A, is reduced by only about 20% of its initial value even after about 6 hours as shown in FIG. 8.

The electron microscopic images of said nanostructured carbon materials synthesized using different synthesis conditions according to the present invention show the sphere-like particles with an average size in diameter ranging from 50 nm to 300 nm as shown in FIG. 4. Said particles are composed of the graphitic nanocoil-shaped particles with an average thickness ranging from 2 nm to 20 nm as shown in FIGS. 5 and 6.

### INDUSTRIAL APPLICABILITY

The nanostructured carbon materials synthesized according to the present invention and having excellent crystallinity and large surface areas exhibit both properties of excellent electrical conductivity and superior catalyst support. Because inexpensive polymers and metal salts are used for synthesizing the nanostructured carbon materials according to the present invention, the production cost is significantly lower compared to other synthetic methods for making nanostructured carbon materials. Furthermore, the characteristics of the resultant nanostructured carbon materials having both excellent crystallinity and large surface area are potentially very useful for making low-temperature fuel cell electrodes due to high efficiency and low cost.

1. A method for synthesizing a nanostructured carbon material, comprising the steps of;
mixing and reacting one or more precursors for one or more polymeric carbon precursors in the presence of one or more transition metal salts, and one or more inorganic oxide materials in a solvent to form a polymeric carbon precursor—transition metal salt—inorganic oxide composite,
catalytically graphitizing said polymeric carbon precursor—transition metal salt—inorganic oxide composite by heat-treating under an inert gas atmosphere to form a nanostructured carbon material—transition metal—inorganic oxide composite,
removing the inorganic oxide material portion from said nanostructured carbon material—transition metal—inorganic oxide composite by using an etching reagent, and
completing the formation of said nanostructured carbon material by removing transition metal by treating said nanostructured carbon material—transition metal composite with an acid to produce a nanostructured carbon material having excellent crystallinity and large surface area.

2. The method of claim 1, wherein said process of mixing and reacting one or more precursors for one or more polymeric carbon precursors in the presence of one or more transition metal salts and one or more inorganic oxide materials in a solvent to form a polymeric carbon precursor—transition metal salt—inorganic oxide composite is replaced with the process of simply mixing one or more polymeric carbon precursors, one or more transition metal salts, and one or more inorganic oxide materials in a solvent to form a polymeric carbon precursor—transition metal salt—inorganic oxide composite

3. The methods of claim 1 and claim 2, wherein said polymeric carbon precursors include typically resorcinol-formaldehyde-gel (RF-gel), phenol-formaldehyde-gel, phenol resin, melamine-formaldehyde-gel, poly(furfuryl alcohol), poly(acrylonitrile), sucrose, polypyrrole, polydivinylbenzene and petroleum pitch.

4. The method of claim 1, wherein said metal salts include the metal salts composed of metal cations including typically iron[Fe], cobalt[Co], nickel[Ni], molybdenum[Mo], vanadium[V], yttrium[Y], zirconium[Zr], niobium[Nb], lithium[Li], magnesium[Mg], aluminum[Al], silicon[Si], potassium[K], calcium[Ca], titanium[Ti], chromium[Cr], manganese[Mn], copper[Cu], zinc[Zn], gallium[Ga], germanium[Ge], arsenic[As], indium[In], tin[Sn], antimony[Sb], lanthanum[La], hafnium[Hf], tantalum[Ta], tungsten[W] and anions including typically acetate[CH₃COO⁻], acetylacetonate[CH₃COCH═C(O⁻)CH₃], fluoride[F⁻], chloride[Cl⁻], bromide[Br⁻], nitrate[NO₃⁻], sulfate[SO₄²⁻], phosphate [PO₄³⁻], oxalate[COO⁻], perchlorate[ClO₄⁻] and alkoxides[RO⁻], and also any one or more mixtures of any combinations of two or more said metal salts listed above are used.

5. The method of claim 1, wherein said inorganic oxides include typically silica[SiO₂], alumina[Al₂O₃], titania[TiO₂], ceria[CeO₂], zirconia[ZrO₂], tin oxide[SnO₂] and yttria[Y₂O₃], and also any one or more mixtures of any combination of two or more said inorganic oxides listed above are used.

6. The method of claim 1, wherein said polymeric carbon precursors are catalytically graphitized by heating under inert gas atmosphere at a temperature between 300° C. and 2500° C.

7. The method of claim 1, wherein said polymeric carbon precursors are catalytically graphitized by heating under an inert gas atmosphere for a time duration between 0.1 and 50 hours.

8. The method of claim 1, wherein said etching reagents include typically hydrofluoric acid[HF], sodium hydroxide[NaOH], potassium hydroxide[KOH], magnesium hydroxide[Mg(OH)₂], calcium hydroxide[Ca(OH)₂] and lithium hydroxide[LiOH], and also any one or more mixtures of any combinations of two or more said etching reagents listed above are used.

9. The method of claim 1, wherein said acid solutions include typically hydrochloric acid[HCl], nitric acid[HNO₃], sulfuric acid[H₂SO₄], hydrofluoric acid[HF], phosphoric acid[H₃PO₄] and acetic acid[CH₃COOH].

10. The method of claim 1, wherein the molar ratio of said polymeric carbon precursor to said metal salt is in the range of 20:1 to 1:2.

11. The method of claim 1, wherein the molar ratio of said polymeric carbon precursor to said inorganic oxide is in the range of 20:1 to 1:2.

12. A nanostructured carbon material, wherein the characteristics of said nanostructured carbon material is characterized by;
the X-ray diffraction graph of said nanostructured carbon material exhibits three peaks; strong (002), second (100), and third (004) peaks, and the measured crystallite size perpendicular to the basal plane (L_{c}) of said nanostructured carbon material is in the range of 2 nm to 20 nm, and
the Raman spectroscopy data of said nanostructured carbon material exhibit a G-line (graphitic-line) at a wave number between 1550 cm⁻¹ and 1610 cm⁻¹, a D-line (disordered-line) at the wave number between 1325 cm⁻¹ and 1385 cm⁻¹, and the intensity ratio of D-line (disordered-line) to G-line (graphitic-line), I_{D}/I_{G}. is less than 1.0, and
the specific surface area measured by the BET method is at least 200 m²/g.

13. A nanostructured carbon material, wherein the characteristics of said nanostructured material is characterized by;
the scanning electron microscope (SEM) images of said nanostructured carbon material exhibit the sphere-like particles with an average size in diameter ranging from 50 nm to 300 nm, and
the transmission electron microscope (TEM) images of said particles are composed of the graphitic nanocoil-shaped particles with an average thickness ranging from 2 nm to 20 nm.
